(19) United States
(12) Patent Application Publication
(10) Pub. No.: US 2007/0223973 A1
(43) Pub. Date: Sep. 27, 2007

(54) Method for Treating the Surface of a Cleaning Roller in an Electrographic Printing or Copying Device

(75) Inventors: Rene Froschl, Brunnthal (DE); Herbert Heimpoldinger, Ampfing (DE)

Correspondence Address: SCHIFF HARDIN, LLP;PATENT DEPARTMENT, 6600 SEARS TOWER, CHICAGO, IL, 60606-6473, US

(73) Assignee: OCE PRINTING SYSTEMS GMBH, Poing (DE)

(21) Appl. No.: 11/628,630

(22) PCT Filed: Jun. 24, 2005
(86) PCT No.: PCT/EP05/06854

§ 371 Date: May 24, 2007

(30) Foreign Application Priority Data
Jun. 25, 2004 (DE) 10 2004 030 863.2

(51) Int. Cl. G03G 21/00; G03G 15/08; G03G 15/09

(52) U.S. Cl. 399/273; 399/283; 399/357

(57) ABSTRACT

In a method for treatment of a surface of a cleaning roller in an electrographic printing or copying device, the cleaning roller is provided as a roller casing tube on which is applied a ceramic layer. The ceramic layer is blasted with a grit. A cleaning roller is also provided according to the method.

### BACKGROUND

Electrophotographic printing or copying devices are, for example, known from DE 102 13 499 A1. They exhibit a design as it is shown in FIG. 1. FIG. 1 thus shows a schematic arrangement of the components used for operation. A charge image carrier 1 (in FIG. 1 a photoconductor drum; the intermediate carrier can likewise be a photoconductor belt) moves with constant speed past the components 2-7, 10-14. The charge image carrier 1 is initially charged by a charge corotron 2. Via a character generator 3 the image to be printed is generated with sharply focused light as a charge image on the charge image carrier 1. The charge image is subsequently inked with toner in a developer station 4. The developer station 4 comprises at least one device for transport of the toner that transports the developer 5 (comprising toner and a carrier) to the charge image carrier 1. In the gap between developer station 4 and charge image carrier 1 the toner thereby transfers onto the charge image carrier 1 corresponding to the charge images. The toner image is finally transferred in a transfer printing station 6 (for example with the aid of a transfer printing corotron 7) onto a recording medium 8 (for example paper) and then fixed in a fixing station 9 (not shown). The charge image carrier 1 is subsequently electrostatically neutralized with a corotron 10. The residual toner still adhering on the charge image carrier 1 is removed for a new image cycle by means of a cleaning device 11, for example a cleaning brush 12 and suction unit 13. Finally the charge image carrier 1 is exposed by a discharge lamp 14 to improve its long-term behavior. The charge image carrier 1 is now prepared for a new printing cycle.

An example of a typical developer station 4 that comprises as a device 15 an applicator roller for transport of toner to a charge image carrier 1 is shown in FIG. 2. The device for transport of the toner is realized in FIG. 2 as a magnet roller with a rotating roller 17 that comprises an electrically-conductive roller casing 22 onto which the developer 5 adheres and with a magnet system 18 arranged internally. The developer 5 is mixed in the developer station 4; the toner thereby charges triboelectrically via friction. Corresponding to the magnetic field lines of the magnet system 18 the developer then builds chains 19 that bridge the developer gap 20 and contact the charge image carrier 1. The toner is detached from the carrier and passes to the charge image carrier 1 due to the charge of the charge image carrier 1 and magnet roller 16. In contrast to this the carrier falls back into the developer station 4. The height of the developer 5 on the roller casing 22 is adjusted via a scraper.

A further developer station can be learned from DE 101 52 892.2. Here a charged toner is moved past a charge image carrier via a biased applicator roller and charge images on the charge image carrier are thereby inked.

Further applicator rollers are known from JP 59 007 384, JP 10 177 303, EP 0 331 425, U.S. Pat. No. 6,327,452; it is in particular described how the surface of applicator rollers are treated in order to achieve a uniform developer layer on the applicator roller. For example, in JP 59 007 384 it is proposed to roughen the ceramic surface of the applicator roller via sandblasting. Or it arises from JP 10 177 303 to produce the surface layer of the applicator roller from a phenol resin that is doped with nitrogen atoms in order to maintain the electrical properties for long time periods under high or low temperature and humidity. EP 0 331 425 describes an applicator roller whose surface is uneven since it exhibits spherical indentations. These are achieved via blasting with spherically-shaped particles. The result of this treatment is that the applicator roller can transport a uniformly thin layer of toner without its surface being too severely contaminated for a long time period. U.S. Pat. No. 6,327,452 describes a further applicator roller in which a ceramic layer is arranged on a roller core made from metal. Before the acceptance of the ceramic layer the roller core is roughened and cleaned via blasting with spherules.

The application rollers used in electrophotographic printing devices comprise (as shown in FIG. 2) at least one roller 17 with a casing (roller casing 22) onto which the toner adheres. However, they are subjected to an unwanted toner accretion process on the roller casing, with the consequence that the transport of toner is negatively influenced.

Techniques with which the unwanted toner accumulation process can be reduced are known from DE 102 13 499 A1 or DE 101 52 892.2. These are based on reducing the adhesive forces between roller casing and toner in that the roller casing receives a special coating. For example, the roller casing can be coated with a porous ceramic spray layer, whereby the pores are filled with a thin liquid polymer lacquer (DE 102 13 499 A1).

DE 101 52 892.2 thereby predominantly deals with a cleaning roller with which toner remaining after the development is cleaned from the surface of an applicator roller. This cleaning roller comprises as a roller casing a tube made from CrNi on which is applied a ceramic layer that is coated with Teflon. The Teflon coating is applied on the roller casing in an aqueous solution and via mechanical redensification. The object of the Teflon layer is on the one hand to prevent an adhesion and wear of the valleys in the ceramic layer by toner; on the other hand it is conceived as a contact and handling protection for the ceramic layer. The application of the Teflon layer requires an elaborate production process in which the individual components must be mixed well. A production process that is not exactly adhered to can already lead to cleaning problems (for example of the applicator roller) in the activation phase of the developer station.

### SUMMARY

An object is to specify a method with which a cleaning roller can be achieved given which toner particles cannot affix in the valleys of the ceramic layer; and the electrical or thermal properties on the surface of the roller casing are additionally more uniform.

In a method for treatment of a surface of a cleaning roller in an electrographic printing or copying device, the cleaning roller is provided as a roller casing tube on which is applied a ceramic layer. The ceramic layer is blasted with a grit. A cleaning roller is also provided according to the method.

### BRIEF DESCRIPTION OF THE DRAWINGS

FIG. 1 is a schematic arrangement of components used for operation in an electrophotographic printing or copying device in connection with German Application DE 102 13 499;

FIG. 2 is an example of a typical developer station that comprises as a toner transport device an applicator roller for transport of toner to a charge image carrier; and

FIG. 3 shows a section of a developer station of an exemplary embodiment of a cleaning roller in an electrographic printing or copying device and having a treated ceramic layer thereon.

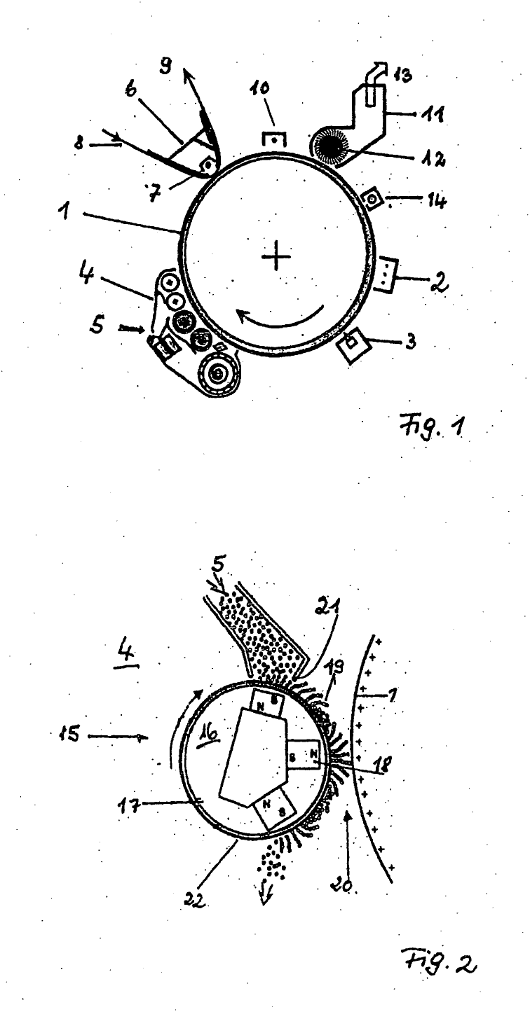

### DESCRIPTION OF THE PREFERRED EMBODIMENTS

For the purposes of promoting an understanding of the principles of the invention, reference will now be made to the preferred embodiment illustrated in the drawings and specific language will be used to describe the same. It will nevertheless be understood that no limitation of the scope of the invention is thereby intended, such alterations and further modifications in the illustrated device, and such further applications of the principles of the invention as illustrated therein being contemplated as would normally occur to one skilled in the art to which the invention relates.

After the application of the ceramic layer (for example via plasma coating) the surface of the roller casing (thus the ceramic layer) is processed again by means of blasting via a grit. The surface of the ceramic layer is hereby cleaned of scalings, oxidation layers and dirt particles. The surface of the ceramic layer is additionally mechanically redensified.

Via this post-processing it is achieved that the toner particles cannot affix in the depressions or valleys of the ceramic layer but rather can always detach again. The electrical and thermal conductivity over the surface of the roller is additionally more uniform. The result is a distinctly improved cleaning behavior in relation to an applicator roller, in particular also in the activation phase of the developer station.

It is particularly advantageous when glass spheres are used as grit. These can have a diameter that lies in the range from approximately 100 to 200 μm. A blasting source for the grit can be arranged approximately 30 mm removed from the roller. The result is particularly good when the glass spheres strike the surface of the roller with a blasting pressure of approximately 2 bar.

However, it is also possible to use a different grit, for example special fused aluminum oxide or quartz.

Plasma coating can be used as a method for application of the ceramic layer. The roller can thereby exhibit a CrNi tube.

The roller of the preferred embodiment is particularly suitable as a cleaning roller for cleaning of an applicator roller that transports toner past a charge image carrier in the development of the charge images. However, it can also be used for cleaning of a charge image carrier.

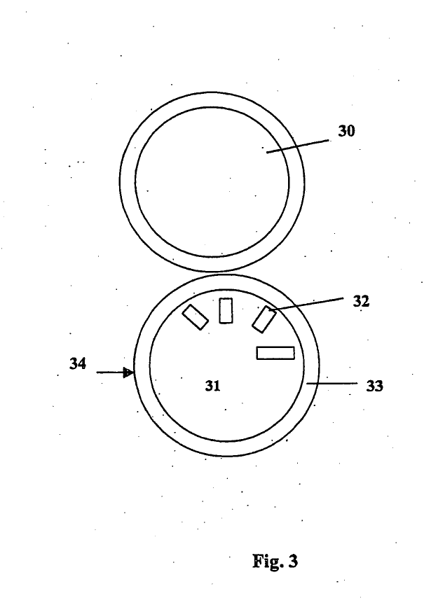

An exemplary embodiment is shown in FIG. 3.

In principle a section of a developer station results from FIG. 3 corresponding to DE 101 52 892.2, which section shows an applicator roller 30 and a cleaning roller 31 arranged adjacent to the applicator roller 30. The applicator roller 30 transports toner to a charge image carrier (not shown). The residual toner transferred onto the charge image carrier must now be cleaned from the applicator roller 30 by the cleaning roller 31. For this the cleaning roller 31 can be provided with a magnet system 32; furthermore, a potential difference can be provided between applicator roller 30 and cleaning roller 31. Aided by the magnet system 32 and the potential, the residual toner then passes onto the cleaning roller 31. In order to optimize a detachment of the toner from the surface of the cleaning roller 31, the cleaning roller 31 comprises a tube 33 as a roller casing (for example made from CrNi) that is covered with a ceramic layer 34. The surface of the ceramic layer 34 is now treated according to the method described above such that the toner easily detaches from the surface of the cleaning roller 31.

While a preferred embodiment has been illustrated and described in detail in the drawings and foregoing description, the same is to be considered as illustrative and not restrictive in character, it being understood that only the preferred embodiment has been shown and described and that all changes and modifications that come within the spirit of the invention both now or in the future are desired to be protected.

We claim as our invention:

1-11. (canceled)

12. A method for treatment of a surface of a cleaning roller in an electrographic printing or copying device, comprising the steps of:
providing the cleaning roller as a roller casing tube on which is applied a ceramic layer; and
blasting the ceramic layer with a grit.

13. A method according to claim 12 in which spheres are used as the grit.

14. A method according to claim 13 in which a diameter of the glass spheres lies in a range from approximately 100 to 200 μm.

15. A method according to claim 13 in which a blasting source for the grit is arranged removed approximately 30 mm from the ceramic layer.

16. A method according to claim 13 in which the glass spheres impact on a surface of the ceramic layer with a blasting pressure of approximately 2 bar.

17. A method according to claim 12 in which special fused aluminum oxide is used as the grit.

18. A method according to claim 12 in which quartz is used as the grit.

19. A method according to claim 12 in which the ceramic layer is cleaned of scalings, oxidation layers, or dirt particles via the blasting with the grit.

20. A method according to claim 12 in which the ceramic layer is redensified via the blasting with the grit.

21. A cleaning roller for cleaning of an applicator roller in a developer station in an electrographic printing or copying device, comprising:
a CrNi tube coated by a ceramic layer whose surface has been treated by blasting with a grit.

22. A developer station in an electrographic printing or copying device, comprising:
an applicator roller that transports toner for development of charge images generated on a charge image carrier; and
a cleaning roller whose surface has been treated by blasting with a grit and which is arranged adjacent to the applicator roller.

23. A developer station of claim 22 wherein the cleaning roller comprises a tube and the cleaning roller surface comprises a ceramic layer blasted with the grit.
